(19) United States
(12) Patent Application Publication
(10) Pub. No.: US 2001/0014864 A1
(43) Pub. Date: Aug. 16, 2001

(54) Apparatus, system, and method for business negotiations and storage medium storing program

(75) Inventor: Daisuke Tazuru, Tokyo (JP)

Correspondence Address: FOLEY & LARDNER, Washington Harbour, 3000 K Street, N.W., Suite 500, P.O. Box 25696, Washington, DC, 20007-8696, US

(73) Assignee: NEC CORPORATION

(21) Appl. No.: 09/781,449

(22) Filed: Feb. 13, 2001

(30) Foreign Application Priority Data
Feb. 14, 2000 (JP) P2000-035745

(51) Int. Cl. G06F 17/60

(52) U.S. Cl. 705/1

(57) ABSTRACT

The present invention relates to an apparatus, a system, and a method for business negotiations which can shorten the lead time for the business negotiations.

An ordering person creates estimate request information, registers the estimate request information on a homepage, and subsequently transmits an estimate request occurrence notice to at least one predetermined prospective dealer via e-mail. Then, the prospective dealer creates estimate information based on the estimate request information, registers the estimate information on the homepage, and subsequently transmits a response registration notice to the ordering person via e-mail. Then, the ordering person references the estimate information on the homepage, decides a dealer to be dealt with from the prospective dealers in consideration of the estimate information and business conditions including a predetermined acceptable price, and subsequently transmits a dealer decision notice via e-mail to the dealer.

### BACKGROUND OF THE INVENTION

1. Field of the Invention

The present invention relates to an apparatus, a system, and a method for business negotiations using the Internet. Moreover, the present invention relates to a storage medium storing a program which is used for the apparatus, the system, and the method described above.

2. Description of the Related Art

For purchasing required products (including services) from a dealer at a desirable cost by a purchasing department of an ordering company, business negotiations are carried out for determining business conditions, such as the price, of the required products. For the case when the required products are used directly to produce merchandise by an ordering side, it is desirable that the ordering side purchases the required products at the necessary time (JIT; Just In Time), that is, procures the required amounts of the product, which has higher quality, at a lower cost, in order that the merchandise to be produced by the ordering side can maintain a stronger ability to overcome price competition. For the case when the required products are used indirectly to produce merchandise by the ordering side, it is also desirable that the ordering side purchases the required products at the necessary time, in order to reduce the cost required by the ordering side.

Therefore, prospective dealers, which are candidates of dealers to be dealt with, are selected in consideration of price, quality, and delivery date of the required products. Then, a prospective dealer which satisfies predetermined business conditions is selected as the dealer by carrying out the business negotiations, so as to order the required products.

In the prior art, business negotiations are generally carried out in the form of interviewing directly with a prospective dealer's person in charge of estimates in order to request an estimate of the cost of the required products and to communicate information related to the required products, such as design and quality of the product (hereinafter referred to as an estimate request), and subsequently acquiring documents related to the estimate of the required products from the prospective dealer's person in charge (hereinafter referred to as an estimate response). Alternatively, the business negotiations are carried out in the form of requesting the prospective dealer's person in charge of estimates to estimate the cost of the required products by telephone, sending information about the required products by mail or by facsimile, and subsequently acquiring documents related to the results of the estimate from the prospective dealer's person in charge by mail or by facsimile.

The following problems occurred when business negotiations are carried out according to the method of the prior art as described above.

A first problem is that the number of prospective dealers for ordering estimate requests related to the required products is limited.

When the estimate request is ordered by a direct interview, business negotiations are carried out only when both a representative from the ordering side (hereinafter referred to as an ordering company) and a representative from the prospective dealer meet. Therefore, it takes a long time to adjust schedules for the interview and to go to the location where the interview is carried out. Thus, in order to purchase the required products at the necessary time, the number of prospective dealers to which estimate requests can be ordered per required product item is naturally limited.

When the estimate request is ordered by telephone, the business negotiations are carried out only when the representative of the ordering company can make contact with the representative of the prospective dealer. Therefore, making contact with the prospective dealer takes a long time since many calls must be made until the representative of the prospective dealer is present. Thus, in order to purchase the required products at the necessary time, the number of prospective dealers to which estimate requests can be ordered per required product item is naturally limited.

A second problem is that lead time for procurement of the required products is long.

As mentioned in the first problem described above, when the estimate request is ordered by a direct interview, it takes a long time to adjust schedules for the interview, for example. Therefore, the lead time for receiving the estimate response becomes long.

When the estimate request is ordered by telephone, a process of reconfirmation is required for confirming the contents of the information which is sent by facsimile related to the required products because the quality of the contents sent by facsimile are often unclear. Moreover, when the estimate request is ordered by mail, preparation of the mail and waiting for the delivery of the documents related to the estimate response takes a long time. Therefore, the lead time for receiving the estimate response becomes long.

Thus, the lead time for receiving the estimate response does not become shorter, and the number of prospective dealers to which the estimate request can be ordered is limited. Therefore, improvement in the efficiency of the business negotiations carried out between the ordering company and the prospective dealer for purchasing required products at a desirable cost is also limited.

### SUMMARY OF THE INVENTION

An object of the present invention is to overcome the problems described above. That is, the object is to share and exchange information with a greater number of prospective dealers by a simple and easy process, so as to shorten the lead time for purchasing required products, and to improve the efficiency of the business negotiations carried out between the ordering company and the prospective dealers for purchasing required products at a desirable cost.

To achieve the object described above, the present invention provides a first apparatus for business negotiations, and comprises: a first registration device (of estimate request information) for creating estimate request information and registering the estimate request information on a homepage on the Internet; a first transmission device (of an estimate request occurrence notice) for transmitting an estimate request occurrence notice to at least one predetermined prospective dealer via e-mail which informs that the estimate request information is registered on the homepage; a first reception device (of a response registration notice) for receiving a response registration notice from the prospective dealer via e-mail which shows estimate information decided by the prospective dealer based on the estimate request information registered on the homepage in response to the estimate request occurrence notice; a first reference device (of estimate information) for referencing the estimate information on the homepage in response to the response registration notice; a decision device (of a dealer) for selecting and deciding on a dealer to be dealt with from the prospective dealers based on the estimate information referenced on the homepage and business conditions registered in advance; and a second transmission device (of a dealer decision notice) for transmitting a dealer decision notice via e-mail to the dealer.

A second apparatus for business negotiations of the present invention comprises: a second reception device (of an estimate request occurrence notice) for receiving an estimate request occurrence notice from an ordering side via e-mail; a second reference device (of estimate request information) for referencing estimate request information on a homepage on the Internet in response to the estimate request occurrence notice; a second registration device (of estimate information) for creating estimate information based on the estimate request information and for registering the estimate information on the homepage; a third transmission device (of a response registration notice) for transmitting to the ordering side via e-mail a response registration notice which shows that the estimate information is registered; and a third reception device (of a dealer decision notice) for receiving from the ordering side via e-mail a dealer decision notice which shows that a dealer is decided in consideration of the estimate information in response to the response registration notice.

A system for business negotiations of the present invention comprises the first apparatus for business negotiations comprising: the first registration device for creating estimate request information and for registering the estimate request information on a homepage, the first transmission device for transmitting an estimate request occurrence notice to at least one predetermined prospective dealer via e-mail to inform that the estimate request information is registered on the homepage, the first reception device for receiving from the prospective dealer via e-mail a response registration notice which shows estimate information decided by the prospective dealer based on the estimate request information registered on the homepage in response to the estimate request occurrence notice, the first reference device for referencing the estimate information on the homepage in response to the response registration notice, the decision device for selecting and deciding on a dealer to be dealt with from the prospective dealers based on the estimate information referenced on the homepage and business conditions registered in advance, and the second transmission device for transmitting a dealer decision notice via e-mail to the dealer; the second apparatus for business negotiations comprising: the second reception device for receiving an estimate request occurrence notice via e-mail, the second reference device for referencing estimate request information on a homepage on the Internet in response to the estimate request occurrence notice, the second registration device for creating estimate information based on the estimate request information and for registering the estimate information on the homepage, the third transmission device for transmitting a response registration notice to the first reception device via e-mail to inform that the estimate information is registered, and the third reception device for receiving a dealer decision notice from the second transmission device via e-mail which informs that a dealer has beem decided in consideration of the estimate information in response to the response registration notice; and a server which manages the homepage.

A storage medium of the present invention stores a program for executing: a first registration step (of estimate request information) for creating estimate request information and for registering the estimate request information on a homepage on the Internet; a first transmission step (of an estimate request occurrence notice) for transmitting an estimate request occurrence notice to at least one predetermined prospective dealer via e-mail; a first reception step (of a response registration notice) for receiving a response registration notice which is transmitted from the prospective dealer via e-mail to inform that estimate information based on the estimate request information is registered in response to the estimate request occurrence notice; a first reference step (of estimate information) for referencing the estimate information on the homepage in response to the response registration notice; a decision step (of a dealer) for selecting and deciding on a dealer to be dealt with from the prospective dealers in consideration of the estimate information referenced on the homepage and business conditions registered in advance; and a second transmission step for transmitting a dealer decision notice via email to the dealer.

Another storage medium of the present invention stores a program for executing: a second reception step (of an estimate request occurrence notice) for receiving an estimate request occurrence notice via e-mail from an ordering side; a second reference step (of an estimate request information) for referencing estimate request information on a homepage on the Internet in response to the estimate request occurrence notice; a second registration step (of estimate information) for creating estimate information based on the estimate request information and for registering the estimate information on the homepage; a third transmission step (of a response registration notice) for transmitting a response registration notice to the ordering side via e-mail to inform that the estimate information is registered, and a third reception step (of a dealer decision notice) for receiving from the ordering side via e-mail a dealer decision notice which shows that a dealer is decided in view of the estimate information in response to the response registration notice.

A method for business negotiations of the present invention comprises the steps of: registering estimate request information on a homepage on the Internet; registering prospective dealers; transmitting an estimate request occurrence notice to the prospective dealers via e-mail to inform that the estimate request information is registered on the homepage; receiving the estimate request occurrence notice and recognizing the estimate request occurrence; and acquiring the estimate request information from the homepage in response to the estimate request occurrence.

Another method for business negotiations of the present invention further comprises a step of creating estimate information based on the estimate request information and registering the estimate information on the homepage.

By using this system which can transmit information to the respective prospective dealers at the same time, it is possible to conduct business negotiations with a greater number of prospective dealers at the same time.

Moreover, it is not required to reconfirm the contents related to the estimate request information and the estimate information, and to obligate the prospective dealers to frequently access the homepage in order to confirm whether information has been registered. Therefore, it is possible to shorten the lead time for conducting business negotiations.

### BRIEF DESCRIPTION OF THE DRAWINGS

FIG. 1 is a block diagram showing the relationship between users of a system for business negotiations of an embodiment according to the present invention.

FIG. 2 is a flow chart showing the work flow of a system for business negotiations of an embodiment according to the present invention.

### DESCRIPTION OF THE PREFERRED EMBODIMENTS

In the following, an embodiment of the present invention is described with reference to the drawings.

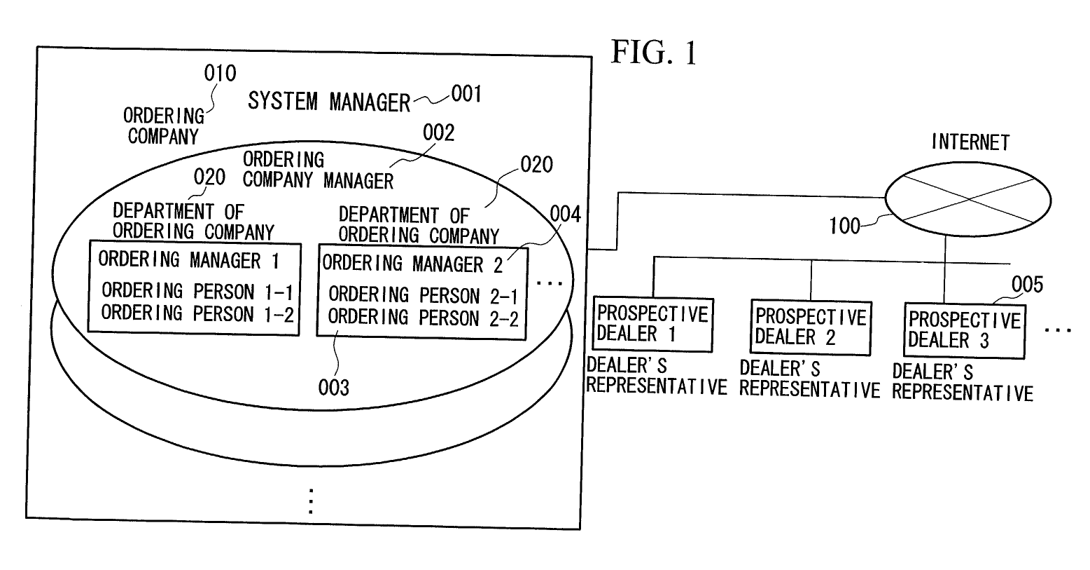

FIG. 1 is a block diagram showing the relationship between users of a system for 20 business negotiations of an embodiment according to the present invention.

In the embodiment of the present invention, business negotiations are carried out effectively according to a basic work flow through the Internet with prospective dealers for purchasing required products at a desirable cost by a department of ordering company, which is represented by a product procurement section. In more detail, estimate request information is registered by the ordering company on an application service on a network which is managed by an internet service provider that provides a connection with the Internet, or on a database providing on a front-end of an application comprising a WWW-server, which is self-managed by the ordering company. Then, the estimate request information is referenced through the Internet by prospective dealers that are permitted to access it by IDs and passwords. After the estimate request information is registered, an estimate request occurrence notice is transmitted to the prospective dealers by automatic transmission of e-mail to immediately inform that an estimate request has occurred. Moreover, the prospective dealers interact with the ordering company via groupware which transmits response registration notices via e-mail to immediately inform that estimate information has been registered. Thus, the basic work flow for purchasing required products is programmed in an electronic system for improving the efficiency of business negotiations in this embodiment.

In this embodiment, users of the system are sorted into five groups: a system manager 001, an ordering company manager 002, an ordering person 003, an ordering manager 004, and prospective dealers 005, in accordance with attributes of the users as shown in FIG. 1.

The system manager 001 is responsible for registering, revising, deleting, and referencing information related to the ordering company 010 when introducing the system into the ordering company 010.

The ordering company manager 002 of the ordering company 010 has the following responsibilities:

referencing and revising information related to the ordering company 010;

registering, revising, deleting, and referencing information related to the participants that participate in the business negotiations (the ordering person 003, the ordering manager 004, and the prospective dealers 005);

registering, revising, and deleting the departments of ordering company 020 to which the participants in the ordering company 010 belong (the ordering person 003 and the ordering manager 004); and

acquiring, in CSV form, all of the information that is exchanged through the system.

The ordering person 003 has the following responsibilities:

creating, registering, revising, and deleting estimate request information;

referencing estimate information from the prospective dealers 005;

deciding on a dealer to be dealt with from the prospective dealers 005 in consideration of the estimate information when the price is under the acceptable price predetermined by the department of ordering company 020;

requesting the ordering manager 004, who is a superior of the ordering person 003, to approve the estimate information when the price exceeds the acceptable price predetermined by the department of ordering company 020 and to decide on a dealer to be dealt with from the prospective dealers 005; and

downloading respectively, in CSV form, the estimate request information registered by the ordering person 003, the estimate information registered by the prospective dealers 005, and the information related to the prospective dealers 005 registered by the ordering company manager 002. Thus, the ordering person 003 is responsible for the estimate request information and is the main user of the system for exchanging information with the prospective dealers 005 in the ordering company 010.

The ordering manager 004 has the following responsibilities:

referencing the estimate request information registered by the ordering person 003 who is a subordinate of the ordering manager 004;

referencing the estimate information that is registered by the prospective dealers 005;

approving the estimate information when the price exceeds the acceptable price and deciding on a dealer to be dealt with from the prospective dealers 005; and

downloading respectively, in CSV form, the estimate request information, the estimate information, and the information related to the prospective dealers 005. Thus, the ordering manager 004 is the user responsible for managing and approving the exchange of information between the ordering person 003 and the prospective dealers 005 in the ordering company 010.

The prospective dealers 005 have the following responsibilities: informing whether the prospective dealers 005 have the intention of creating the estimate information based on the estimate request information from the ordering company 0 10, creating and registering the estimate information in consideration of the estimate request, and referencing and revising the information related to the prospective dealers 005.

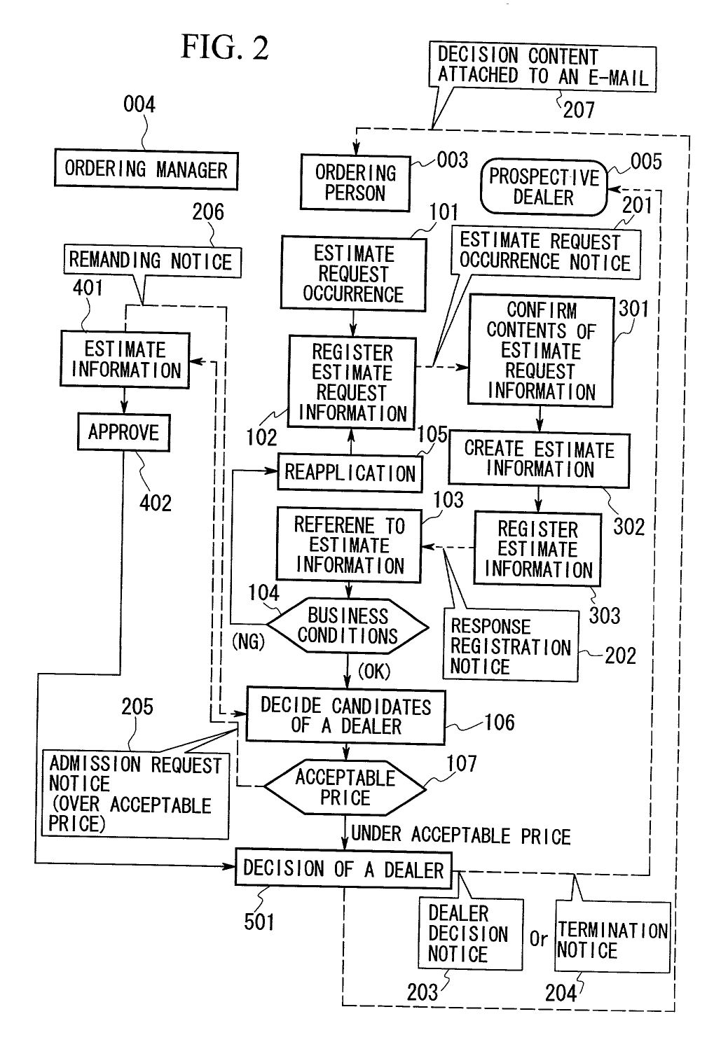

In the embodiment of the present invention, the system for carrying out business negotiations includes: an execution environment of a business application for executing the basic work flow that is programmed in the system as shown in FIG. 2; a WWW-server (which is not shown in FIG. 2) which displays an execution result acquired by the execution of the execution environment on the Internet 100; a database server wherein the execution result and all of the information registered by the ordering company and the prospective dealers are registered; and an ordering apparatus which includes an ordering computer which is installed with a Web browser and can be connected to the Internet 100, a transmitting-receiving environment for e-mail which can be used in the ordering computer, and a prospective dealer's computer. Moreover, the system is set so as to be usable in response to an ID and password which correspond to the respective users, and so as to be able to register information.

The users of the system enter an ID and password, which are assigned to each other in advance, into the ordering computer which is connectable for the Internet 100, so as to access the WWW-server through the Internet 100. Then, the users can use functions which are provided in accordance with the ID, and obtain information which the users are permitted to accessed according to the ID.

In the following, the basic work flow of the system is described.

In FIGS. 1 and 2, the ordering person 003 accesses a predetermined homepage on the WWW-server through the Web browser in response to the estimate request occurrence 101 at the department of ordering company 020, such as the product procurement section of the ordering company 010. Then, the ordering person 003 inputs an ID and password, which are assigned in accordance with the ordering person 003, into blanks for inputting the ID and password on an initial screen of the homepage. When the ID and password have been confirmed for access to the system, the ordering person 003 is permitted to login to the system.

After the ordering person 003 creates estimate request information, the ordering person 003 registers the estimate request information which includes information regarding to the required products which is required in order to estimate the price and desired time limit for providing estimate information based on the estimate request information, and attached documents, such as designs and specifications, by using the function of the first registration device (registration of estimate request information 102 shown in FIG. 2).

The prospective dealers 005, which are registered by the ordering manager 005, can be selected for transmitting an estimate request occurrence notice by the ordering person 003. Moreover, the prospective dealers 005 can be grouped and registered in accordance with the respective ordering person 003. The prospective dealers 005 can also be selected individually or in a group in accordance with the ordering person 003.

When the estimate request information is registered on the homepage by the first registration device, the estimate request occurrence notice 201 is automatically transmitted via e-mail by using the function of the first transmission device for transmitting an e-mail in response to the registration of the estimate request information 102 by the ordering person 003 to the prospective dealers 005 whose e-mail addresses are registered as information related to the prospective dealers 005. Thereby, the prospective dealers 005 can reference the estimate request information as soon as the estimate request information is registered, without frequently referencing the homepage to confirm the registration of estimate request information. Thereby, the prospective dealers 005 can save trouble in referencing the registration of estimate request information and the lead time for referencing the estimate request information can be decreased.

After receiving the estimate request occurrence notice 201 via e-mail by using the function of the second reception device, the prospective dealers 005 access the homepage of the address which is registered in the e-mail. Then the prospective dealers 005 input an ID and password, which are assigned in accordance with the prospective dealers 005, into blanks for inputting the ID and password on the initial screen of the homepage. When the ID and password have been confirmed for access to the system, the prospective dealers 005 can login to the system.

The prospective dealers 005 confirm the contents of the estimate request information, registered by the ordering person 003, by using the function of the second reference device for referencing a list of the estimate request information on the homepage (confirmation of the contents of the estimate request information 301 shown in FIG. 2). Because the system is set to admit access only when the ID and password have been confirmed for access, the list showing the estimate request information is permitted to be displayed on the homepage to the prospective dealers 005 for which the ID and password have been confirmed for access.

After the confirmation of the contents of the estimate request information 30 1, when the prospective dealers 005 have the intention of creating estimate information based on the estimate request information, the prospective dealers 005 can indicate the intention to the ordering person 003 in advance by using the function of the transmission device, which can be set for transmitting an e-mail indicating this intention which can be set in accordance with the estimate request information. When the prospective dealers 005 have no intention of creating estimate information, the prospective dealers 005 can indicate this in the same manner as described above.

When the prospective dealers 005 create the estimate information, the prospective dealers 005 create the estimate information based on the estimate request information (creation of estimate information 302) and register the estimate information by using the function of the second registration device (registration of the estimate information 303). The estimate information includes the estimated price and attached documents related to detailed information of the estimate information.

After registration of the estimate information 303, a response registration notice 202, which shows that the registration of the estimate information 303 has been completed, is automatically transmitted via e-mail to the ordering person 003 from the prospective dealers 005 in response to the registration of the estimate information 303 by using the function of the third transmission device.

After receiving the response registration notice via e-mail by using the function of the first reception device, the ordering person 003 accesses the homepage of the address which is described in the e-mail. Then, the ordering person 003 inputs an ID and password, which are assigned in accordance with the ordering person 003, into blanks for inputting the ID and password on an initial screen of the homepage. When the ID and password are confirmed for access to the system, the ordering person 003 is permitted to login to the system.

Then, the ordering person 003 references a list, which lists the estimate request information and the estimate information, by using the function of the first reference device for referencing the list on the homepage (reference of estimate information 103). At that time, the ordering person 003 can also reference detailed information in accordance with the respective prospective dealers 005.

Then, the ordering person 003 compares all of the estimate information to confirm the detailed contents of the estimate information.

When the confirmed contents of the estimate information does not fulfill the business conditions 104, which include the acceptable price 107 and are registered in advance, the business conditions 104 are determined by a function of a reapplication device. In detail, new estimate request information can be registered on the homepage by using the function of the first registration device, and the estimate request occurrence notice can be transmitted to the predetermined prospective dealers 005 again by using the function of the first transmission device (reapplication 105). The final business conditions can be determined by repeatedly using the function of the reapplication device for executing the reapplication 105. The function of the reapplication device takes charge of the estimate information and its relevant attached files, and adds and deletes information and documents related to the reapplication 105 in order to improve the precision of the final business conditions and to decrease the number of prospective dealers 005.

Then, the ordering person 003 selects the estimate information which satisfies the business conditions 104 and which will be finally accepted, and decides the candidates of the dealers to be dealt with 106.

For the decision of the dealer 501, the acceptable prices 107 are set in accordance with the department of ordering company 020 registered by the ordering company manager 002. When the estimated price of the estimate information is under the acceptable price 107, the decision of the dealer 501 is executed by using the function of the decision device for deciding the dealer to be dealt with from the candidates of the dealer. Then, a dealer decision notice 203 is automatically transmitted to the dealer whose e-mail address has been registered by the ordering company manager 002 by using the function of the second transmission device. Preferably, a termination notice 204 is automatically transmitted to the other prospective dealers, other than the dealer decided who is to be dealt with, whose e-mail addresses have been registered by the ordering company manager 002 by using a function of a fourth transmission device for informing that the estimate request has been terminated.

When the estimated price of the estimate information exceeds the acceptable price 107, an acceptance request notice 205 is set to be automatically transmitted via email to the ordering manager 004 whose e-mail address has been registered by the ordering company manager 002 by using a function of a sixth transmission device for confirming whether an estimated price listed in the estimate information can be accepted.

Then, the ordering manager 004 considers the estimate information 401 and the decision of the candidates of the dealers 106. Then, when the ordering manager 004 executes approval 402 for accepting the estimated price, the decision of the dealer 501 is executed. After the decision of the dealer 501 has been executed, a dealer decision notice 203 is automatically transmitted via e-mail to the dealer whose e-mail address has been registered in advance by the ordering company manager 002, by using the function of the second transmission device. A termination notice 204 which informs that the estimate request has been terminated is automatically transmitted to other prospective dealers, other than the dealer who is to be dealt with, whose e-mail addresses have been registered by the ordering company manager 002, by using the function of the fourth transmission device.

Alternatively, when the ordering manager 004 does not execute approval 402 of the decision of the candidates of the dealers 106, the ordering manager 004 transmits a remanding notice 206 automatically via e-mail to the ordering person 003 whose e-mail address has been registered in advance by the ordering company manager 002. Then, the business negotiations are returned to the state where the decision of the candidates of the dealers 106 has not yet been executed, and the ordering person 003 considers again the execution of the decision of the dealer 501.

After the decision of the dealer 501 has been executed, the estimate information provided by the prospective dealers 005 (including the documents attached to the estimate information) and the decision content are automatically transmitted via e-mail to the ordering person 003 whose address has been registered in advance by the ordering company manager 002, by using a function for transmitting an e-mail including the decision content and the estimate information. The transmission of the decision content e-mail improves the efficiency for carrying out the work flow through the system in the ordering company 010 wherein groupware is introduced to carry out the work flow.

As described above, the characteristics of the system according to the present embodiment are as follows.

1. The system for carrying out business negotiations uses an application, which is developed by a WWW-server technique and the like, for exchanging information alternately between the ordering company and the prospective dealers.

2. After executing respective steps, such as the registration of the estimate request information 102, the registration of the estimate information 303, and the decision of the dealer 501, the application is set to automatically transmit an e-mail for informing that the respective steps have been completed, and the following steps may be started.

3. By automatically informing via e-mail that the business negotiations have occurred, the prospective dealers are not required to login to the system frequently in order to know that the business negotiations have occurred.

4. The ordering person can respectively group information shared among the prospective dealers which is to be registered and used.

5. The system may be set to take charge of the information exchanged through the system thereby eliminating a step for inputting the information again, and can exchange information continuously by adding, for example, new information, business conditions, and attached files that are relevant to the exchanged information.

6. The final decision information of the business negotiations are transmitted to the ordering person, who starts the business negotiations, by attaching the information to an e-mail as a file. The system utilizes groupware using the e-mail and the attached file to carry out the work flow.

Therefore, the following effects can be obtained in the present invention.

Since the installation of a special application other than the Web browser in the ordering computer can be eliminated, the system is easy to use by using the application through the WWW-server.

By using the system, it is possible to request estimates from a greater number of prospective dealers 005 at the same time.

During the registration of the estimate request information 102, it is possible to register detailed information, which is attached to the estimate request, thereby eliminating the reconfirmation of the contents related to the estimate request information.

The ordering person 003 is not required to transmit information to each of the prospective dealers 005 individually, by using the function for executing automatic e-mail transmission (201-206) during the registration of information related to the business negotiations.

It is not necessary to obligate the prospective dealers 005 to frequently access the homepage in order to confirm whether information has been registered by using automatic e-mail transmission.

By transmitting the decision content attached to an e-mail 207, it is possible to smoothly and easily handle the information exchanged through the system to the groupware which is introduced into the system in order to carry out the work flow in the ordering company 010.

By outputting the information in CSV form, the information used for the business negotiations (such as the estimate request information, the estimate information, and the information related to the prospective dealers) can be handled by the system of the ordering company 010.

A storage medium stores a program for executing the steps of the work flow which is shown in FIG. 2. The program is executed by the computer of the ordering apparatus and the computers of the prospective dealers apparatuses. Various storage media, such as various disc media and semiconductor memories, are used for the storage media.

What is claimed is:

1. An apparatus for business negotiations, comprising:
a first registration device for creating estimate request information and registering the estimate request information on a homepage on the Internet;
a first transmission device for transmitting an estimate request occurrence notice to at least one predetermined prospective dealer via e-mail to inform that the estimate request information is registered on the homepage;
a first reception device for receiving from the prospective dealer via e-mail a response registration notice which shows estimate information decided by the prospective dealer based on the estimate request information registered on the homepage in response to the estimate request occurrence notice;
a first reference device for referencing the estimate information on the homepage in response to the response registration notice;
a decision device for selecting and deciding a dealer to be dealt with from the prospective dealers based on the estimate information referenced on the homepage and business conditions registered in advance; and
a second transmission device for transmitting a dealer decision notice via e-mail to the dealer.

2. An apparatus for business negotiations according to claim 1, further comprising a reapplication device for registering new estimate request information by the first registration device and transmitting an estimate request occurrence notice to the predetermined prospective dealer again by the first transmission device when the business conditions registered in advance are not agreed on.

3. An apparatus for business negotiations according to claim 1, further comprising a fourth transmission device for sending, to the prospective dealers other than the dealer decided on via e-mail termination notices which inform the prospective dealers that the estimate request has been terminated.

4. An apparatus for business negotiations according to claim 1, further comprising a fifth transmission device for sending the estimate information to a person who is responsible for the estimate request information via e-mail after the dealer has been decided.

5. An apparatus for business negotiations according to claim 1, wherein the prospective dealers are sorted in accordance with the persons who are responsible for the estimate request information.

6. An apparatus for business negotiations according to claim 1, wherein the business conditions include an acceptable price.

7. An apparatus for business negotiations according to claim 6, further comprising a sixth transmission device for transmitting, to an ordering manager, an acceptance request notice which confirms whether the price, which is listed in the estimate information and exceeds the acceptable price, can be accepted.

8. An apparatus for business negotiations according to claim 7, wherein the decision device decides the dealer after the ordering manager has accepted the price listed in the estimate information.

9. An apparatus for business negotiations, comprising:
a second reception device for receiving an estimate request occurrence notice from an ordering side via e-mail;
a second reference device for referencing estimate request information on a homepage on the Internet in response to the estimate request occurrence notice;
a second registration device for creating estimate information based on the estimate request information, and registering the estimate information on the homepage;
a third transmission device for transmitting a response registration notice to the ordering side via e-mail to inform that the estimate information is registered; and
a third reception device for receiving a dealer decision notice based on the estimate information from the ordering side via e-mail in response to the response registration notice.

10. A system for business negotiations, comprising:
a first apparatus for business negotiations comprising a first registration device for creating estimate request information and registering the estimate request information on a homepage on the Internet, a first transmission device for transmitting an estimate request occurrence notice to at least one predetermined prospective dealer via e-mail to inform that the estimate request information is registered on the homepage, a first reception device for receiving from the prospective dealers via e-mail a response registration notice which shows estimate information decided by the prospective dealer based on the estimate request information registered on the homepage in response to the estimate request occurrence notice, a first reference device for referencing the estimate information on the homepage in response to the response registration notice, a decision device for deciding a dealer to be dealt with from the prospective dealers based on the estimate information referenced on the homepage and business conditions registered in advance, and a second transmission device for transmitting a dealer decision notice to the dealer via e-mail;
a second apparatus for business negotiations comprising a second reception device for receiving an estimate request occurrence notice via e-mail, a second reference device for referencing estimate request information on a homepage on the Internet in response to the estimate request occurrence notice, a second registration device for creating estimate information based on the estimate request information and registering the estimate information on the homepage, a third transmission device for transmitting a response registration notice to the first reception device via e-mail to inform that the estimate information is registered, and a third reception device for receiving a dealer decision notice based on the estimate information from the second transmission device via e-mail in response to the response registration notice; and
a server for managing the homepage.

11. A storage medium which stores a program for executing:
a first registration step of creating estimate request information and registering the estimate request information on a homepage on the Internet;
a first transmission step of transmitting an estimate request occurrence notice to at least one predetermined prospective dealer via e-mail;
a first reception step of receiving a response registration notice which is transmitted from the prospective dealer via e-mail which shows estimate information decided by the prospective dealer based on the estimate request information registered in response to the estimate request occurrence notice;
a first reference step of referencing the estimate information on the homepage in response to the response registration notice;
a decision step of selecting and deciding a dealer to be dealt with from the prospective dealers based on the estimate information referenced on the homepage and business conditions registered in advance; and
a second transmission step of transmitting a dealer decision notice via e-mail to the dealer.

12. A storage medium which stores a program for executing:
a second reception step of receiving an estimate request occurrence notice via email from an ordering side;
a second reference step of referencing estimate request information on a homepage on the Internet in response to the estimate request occurrence notice;
a second registration step of creating estimate information based on the estimate request information and registering the estimate information on the homepage;
a third transmission step of transmitting a response registration notice to the ordering side via e-mail to inform that the estimate information is registered; and
a third reception step of receiving from the ordering side via e-mail a dealer decision notice which is decided by the ordering side in view of the estimate information in response to the response registration notice.

13. A method for business negotiations, comprising:
registering estimate request information on a homepage on the Internet;
registering prospective dealers;
transmitting to the prospective dealers via e-mail an estimate request occurrence notice which informs that the estimate request information is registered on the homepage;
receiving the estimate request occurrence notice and recognizing the estimate request occurrence; and
acquiring the estimate request information from the homepage in response to the estimate request occurrence notice.

14. A method for business negotiations according to claim 13, which further comprises a step of creating estimate information based on the estimate request information and registering the estimate information on the homepage.
